(19) United States
(12) Patent Application Publication
(10) Pub. No.: US 2003/0191943 A1
(43) Pub. Date: Oct. 9, 2003

(54) Methods and arrangements to register code

(76) Inventors: David I. Poisner, Folsom, CA (US); James A. Sutton, Portland, OR (US); David W. Grawrock, Aloha, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/116,923

(22) Filed: Apr. 5, 2002

(51) Int. Cl. H04L 9/00

(52) U.S. Cl. 713/181

(57) ABSTRACT

Methods and arrangements to register code are described. Many embodiments may comprise determining an identity such as a hashed identity, digest value, digital signature, or the like, and registering resident code that defines a secure environment, to provide a basis for a system trustworthiness evaluation by another secure environment within the system, a secure environment within another system, a remote system, or the like. Some embodiments comprise transmitting an instruction to store the identity in a repository or memory inaccessible to insecure or untrustworthy hardware and/or software. Several embodiments may comprise verifying a request to access the identity. Other embodiments may comprise storing the identity in a temporary register, such as a register in a hub and/or in memory coupled with an input/output (I/O) hub or within a memory controller hub.

### BACKGROUND

The increasing number of financial and personal transactions being performed on local or remote computers has instigated a need for the establishment of trustable or secure environments. More particularly, the secure environment attempts to address a problem of loss of privacy. For example, private data like credit card data, medical report data, bank account data, or the like, stored on a computer to facilitate transactions, or even to manage personal finances, may be accessed, corrupted or abused by another user of the same computer or by a networked system via a local area network (LAN), a wide area network (WAN), or by system interconnections established through access to the Internet. Users do not want their private data made public, altered or used in inappropriate transactions, regardless of whether the private data resides only on their personal computer or on a remote computer as a result of a transaction involving the private data across a network.

Existing secure environments designed to prevent the loss of privacy include isolated systems that may utilize a closed set of only trusted software. Although theses systems do not account for attacks from within the network, such systems provide protection against outside attacks from potentially hostile code. Some of these systems, however, are disadvantageous to the extent that they do not allow the simultaneous use of common, commercially available operating system and application software. Further, the establishment of larger networks degrades the protections offered for these secure environments.

One solution includes isolation of a secure environment from an insecure environment within the system. Many of these implementations attempt to isolate the untrustworthy software or code from the secure environment, however, they inherently trust software such as the operating system. The operating system, for instance, may be trustworthy as received from the original manufacturer but may be corrupted by updates or upgrades from untrustworthy or potentially hostile sources. Any piece of hardware and/or software that has access to the memory, such as a processor, bus master, input/output (I/O) device, etc., can potentially corrupt the operating system prior to and/or during execution, compromising the integrity of the secure environment. Further, applications that are exposed to modification with interconnection to a network are isolated in the insecure environment, preventing access to and exchange of private data with other trustworthy systems. Thus, a side effect of the isolation characteristic of these systems prevents, for example, exchange of private data with an on-line banking system.

### BRIEF FIGURE DESCRIPTIONS

In the accompanying drawings, like references may indicate similar elements:

FIG. 1 depicts an embodiment of a processor-based system with a hub and token to register code for a secure environment.

FIG. 2 depicts an embodiment of an apparatus to register code for a secure environment.

FIG. 3 depicts a flow chart of an embodiment to register code for a secure environment.

FIG. 4 depicts an embodiment of a machine-readable medium comprising instructions to register code for a secure environment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments. The variations of embodiments anticipated for the present invention are too numerous to discuss individually so the detailed descriptions below are designed to make such embodiments obvious to a person of ordinary skill in the art.

Methods and arrangements to register code are described. Many embodiments may comprise determining an identity such as a hashed identity, digest value, digital signature, or the like, and registering resident code that defines a secure environment, to provide a basis for a system trustworthiness evaluation by another secure environment within the system, a secure environment within another system, a remote system, or the like. Some embodiments comprise transmitting a privileged instruction to store the identity in a repository or memory inaccessible to insecure or untrustworthy hardware and/or software. Several embodiments may comprise verifying a request to access an identity in the repository or memory. Other embodiments may comprise storing the identity in a temporary register, such as a register in a hub and/or in memory coupled with an input/output (I/O) hub or within a memory controller hub. Further embodiments may register resident code upon entering or initiating a secure environment such as code for a secure virtual machine monitor (SVMM).

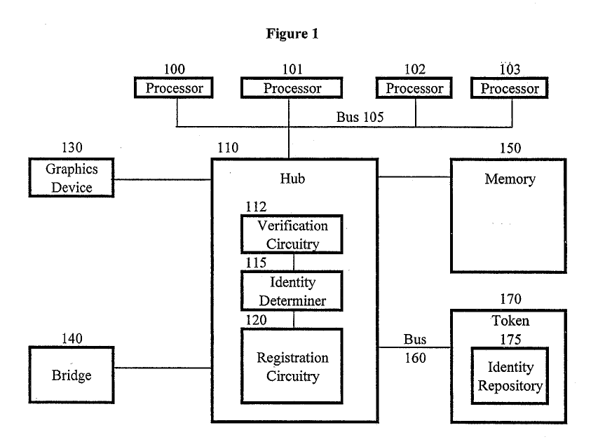

Referring now to FIG. 1, there is shown an embodiment of a processor-based system with a hub 110 and token 170 to register code for a secure environment. The embodiment may comprise processors such as processors 100, 101, 102, and 103; bus 105; hub 110; graphics device 130; bridge 140; memory 150; bus 160; and token 170. Processors 100, 101, 102, and 103 may execute instructions in response to requests from operating system software and application software. In particular, processors 100, 101, 102, and 103 may be coupled to hub 110 to execute memory-resident code and access the contents of memory 150. Processors 100, 101, 102, and 103 may also receive data from or transmit data to graphics device 130, bridge 140, and token 170.

In the present embodiment, processors 100, 101, 102, and 103 may comprise circuitry to initiate a determination of the identity for a memory-resident code of a secure environment. The identity may comprise data representing the code of resident software in the processor system. For example, the identity may comprise data to describe characteristics of code such as characteristics for use in evaluating the trustworthiness of memory-resident code that defines a secure environment. In some embodiments, the identity may comprise a hash of the resident code. In many embodiments, the identity may comprise a cryptographic hash of memory-resident code such as SHA-1 or MD5 or like algorithm. In other embodiments, the identity may comprise a lossy or lossless compression of a resident code, a resident code, or the like. The identity may also be encrypted to prevent alteration via an encryption algorithm such as DES, 3DES, AES, and/or RSA algorithms. In one embodiment, the identity may be RSA-encrypted with the private key that may serve as an integrity metric for the processor-based system, or the like.

In further embodiments, processors 100, 101, 102, and 103 may comprise circuitry to execute a trusted module, wherein the trusted module may comprise registered code verified or authenticated by or for a code manufacturer, the manufacturer of hub 110, the manufacturer of processor 100, 101, 102, and/or 103, or by code verified or authenticated by another trusted module. The trusted module may further comprise code registered as memory-resident code that defines a secure environment.

In many of these embodiments, a processor of processors 100, 101, 102, and 103 may comprise circuitry such as bus logic to initiate a determination of the identity by transmitting an instruction to hub 110. The instruction may comprise an instruction by a trusted module or a special bus cycle on bus 105. In some embodiments, the circuitry may transmit a privileged instruction comprising the identity or an address associated with the identity along with or subsequent to a sequence of actions or bits. In many embodiments, the privileged instruction may comprise an instruction that may be at a privilege level that is not available to an operating system such as a privileged level of ring zero. In other embodiments, the circuitry may set a bit of a register so hub 110 may accept a transaction and/or a privileged instruction. For example, processor 100 or a thread representing a logical processor may be executed on processor 100, 101, 102, and/or 103 may execute microcode to cryptographically hash a memory-resident copy of security initialization software (SINIT). SINIT, in one embodiment, may comprise code supplied by the manufacturer of hub 110. The hashing algorithm may generate a 20-byte digest value of the memory-resident copy of SINIT. In many of these embodiments, the digest value of SINIT may comprise a fixed size such as 20 bytes. In other embodiments, the size of the digest value may vary.

The logical processor may set a bit of a command register and/or issue a privileged instruction to facilitate a transaction during normal bus cycles to initiate a determination of the identity by hub 110. For example, processor 100 may comprise secure enter (SENTER) logic to support the execution of SENTER instructions that may initiate trusted operations. The logic may comprise bus logic to support bus messages on bus 105 in support of SENTER operations. The use of bus messages may increase the security or trustability of the system by reducing or eliminating the opportunity for potentially hostile, untrusted code to snoop substantially secure or protected bus transactions. The bus messages may issue only in response to security instructions and/or in accordance with a security protocol.

After initializing the secure environment, trusted module(s) and hub 110 may protect memory locations from access by code that may not be registered for the secure environment. The trusted module(s) may protect the memory locations by preventing or substantially preventing access except through trusted modules.

In further embodiments, the digest value may transmit to hub 110 with a special bus cycle. In one embodiment, the special bus cycle or privileged transaction may be initiated at a pre-designated interval in accordance with a security protocol. In some embodiments, the manufacturer of hub 110, a processor, or the like may define the security protocol. Hub 110 may recognize the special bus cycle or privileged transaction. In response, hub 110 may receive the identity. The identity of SINIT may then be stored in protected memory associated with identity repository 175 to register the memory-resident copy of SINIT. On the other hand, in response to a special bus cycle at an interval that may not conform to the security protocol, hub 110 may ignore the transmission and/or a protection mechanism of hub 110 may set a flag and/or initiate a reset of the processor system or a subsystem thereof.

The memory-resident copy of SINIT may then be authenticated by comparing the identity derived from the memory-resident copy of SINIT against the identity associated with the identity repository 175. Subsequent to authentication, the memory-resident copy of SINIT may comprise a trusted module and may be executed by one or more processors of processors 100, 101, 102, and 103 or by one or more threads being executed by one or more processors of processors 100, 101, 102, and 103. As a trusted module, the memory-resident copy of SINIT may hash and/or initiate a determination of the identity of additional code during a normal bus cycle of bus 105. For example, SINIT may hash a resident code such as a security virtual machine monitor (SVMM) to generate a digest value. The digest value may be forwarded to hub 110. In some embodiments, the digest value may be encrypted prior to forwarding the digest value to hub 110. In other embodiments, the digest value or an encrypted version thereof may be stored at a memory location and an address associated with a memory location may transmit to hub 110.

Hub 110 may serve as an interface between processors 100, 101, 102, and 103 and graphics device 130, bridge 140, memory 150, and token 170. Hub 110 may receive a signal, derive an identity for resident code based upon the signal, and store the resident code in protected memory to associate the identity with identity repository 175. In one embodiment, hub 110 may store the protected code in protected memory by generating a substantially secure transaction to transmit the identity to token 170. In another embodiment, hub 110 may generate a substantially secure transaction to store an address in the identity repository 175, wherein the address may indicate the location of the identity in protected memory.

Hub 110 may access memory contents of memory 150 and relay data and code between processors 100, 101, 102, and 103 and input and output (I/O) devices, such as graphics device 130 and bridge 140. In some embodiments, hub 110 may comprise a memory controller and an input-output (I/O) controller. The memory controller may couple with memory 150, to access memory in response to instructions from I/O devices and/or processors 100, 101, 102, and 103. In many of these embodiments, hub 110 may support standard I/O operations on I/O busses such as peripheral component interconnect (PCI), accelerated graphics port (AGP), universal serial bus (USB), low pin count (LPC) bus, or the like.

In several embodiments, hub 110 may comprise logic to prevent direct access to protected addresses of memory 150. For instance, processor 100 may hash a resident code and store the resulting identity on a protected page of memory 150. A trusted module such as SVMM may deny direct access to protected memory of memory 150 by some system components or agents like graphics device 130, bridge 140, or other agents that may not be trusted. The trusted module may also deny access by code such as other trusted modules or an operating system to enhance secure or trusted operations.

Hub 110 may comprise verification circuitry 112, identity determiner 115 and registration circuitry 120. Verification circuitry 112 may verify compliance of a signal with a security protocol, wherein the signal is transmitted from processor 100, 101, 102, and/or 103 to request registration of resident code. For example, processor 100 may transmit a privileged instruction to hub 110 comprising the identity of a resident code. Verification circuitry 112 may determine that the processor that transmitted the signal incorporated a privileged instruction of a trusted module having a privilege level to make the request. Hub 110 may then proceed to register the code. In other embodiments, verification circuitry 112 may verify that a sequence of instructions may have been received prior to or may be received after making the request. In further embodiments, verification circuitry 112 may verify that the privileged instruction comprises a particular sequence of bits such as starting bits, ending bits, or the like.

Hub 110 may comprise identity determiner 115 to derive an identity from a signal transmitted from processor 100, 101, 102, and/or 103. For example, processor 100 may transmit an instruction to hub 110 indicating that the identity resides at an address in memory 150. Hub 110 may then retrieve the identity from the protected memory addresses or pages in memory 150.

In many embodiments, identity determiner 115 may identify a privileged instruction or message from a processor. The privileged instruction may comprise an instruction from a trusted module such as SVMM. Some of these privileged instructions may comprise instructions to transfer the identity to token 170. Identity determiner 115 may recognize that the instruction may comprise the identity by recognizing that the instruction comprises an address associated with token 170. In other embodiments, the hub 110 may comprise a repository to store the identity and, in further embodiments, the protected memory to store the identity may reside elsewhere within the processor system.

Registration circuitry 120 may transmit the identity, or an address thereof, to token 170 via a substantially secure transaction. After hub 110 may determine part of the identity, registration circuitry 120 may initiate a substantially secure transaction on bus 160. For example, registration circuitry 120 may transmit the identity via a special cycle on bus 160. The identity may transmit to token 170 in enough writes to accommodate the hash size and some additional bits to give control information to token 170 such as five 32 bit write transactions. Components or devices other than token 170 that couple with bus 160 may not recognize and/or may not be able to snoop the special cycle on bus 160.

In some embodiments, registration circuitry 120 may initiate a substantially secure transaction with token 170 with an instruction such as a privileged instruction, an instruction to set a bit of a register, or code to initiate special cycles on a bus. For instance, registration circuitry 120 may couple with token 170 to provide a dedicated port for transmission to token 170. A transaction layer of the registration circuitry may use a privileged packet-based protocol to transmit the identity across a bus 160. The transaction layer may encapsulate data for transmission in a format that may be recognized by token 170 but may not be recognized by other devices coupled with bus 160.

In other embodiments, bus 160 may comprise a point-to-point bus and registration circuitry 120 may dedicate one or more lanes to a transaction between registration circuitry 120 and token 170. In some of these embodiments, dedication of the one or more lanes may occur during or after initiation execution of SINIT and/or SVMM. For example, a queue may comprise a 4-byte wide queue to facilitate an 8b/10b-encoding scheme to encode the bytes and transmit the identity serially across lanes of bus 160.

Registration circuitry 120 may also comprise a register or queue to store part of the identity for a resident code of a secure environment. In many embodiments, the register or queue may store the identity temporarily to facilitate transmission of the identity to token 170 such as situations wherein token 170 is not ready to accept the identity or registration circuitry 120 is not ready to transmit the identity. For instance, bus 160 may transmit and/or receive packets from one or more processors of processors 100, 101, 102, and 103 or from one or more threads operating on one or more processors of processor 100, 101, 102, and 103, substantially simultaneously.

In further embodiments, the register or queue may act as a delimiting register. For example, in embodiments wherein the size of the identity may vary, the delimiting register may receive data or an instruction to indicate the end of the identity. In several of these embodiments, the identity may be received by hub 110 piecemeal, or in parts. In such embodiments, processors 100, 101, 102, and 103 may continue to perform other functions between transmissions of parts of the identity. In many of these embodiments, registration circuitry 120 may transmit a part of the identity to token 170 after the part is received. In other embodiments, registration circuitry 120 may store the parts of the identity and transmit the identity as a whole in an atomic transaction to token 170. In other embodiments, registration circuitry 120 may receive parts of the identity for more than one resident code from different processors or threads and store the parts until identity for one code is complete or until bus 160 is available to transmit a part to token 170.

Referring still to FIG. 1, bus 160 may comprise a LPC bus. Bus 160 may couple with additional devices such as a keyboard. In other embodiments, bus 160 may comprise another type of bus such as a point-to-point bus, USB, PCI bus, or the like.

Token 170 may facilitate evaluation of trustworthiness of the processor-based system by managing the identity. In the present embodiment, token 170 may store the identity in response to a substantially secure transaction and prevent access to the signature by agents or code, or in a manner other than the agent, code and/or manner defined by a security protocol. Agents other than hub 110 may not have access to the identity managed by token 170. For example, a secure environment in the processor-based system may be initiated by hub 110 after receiving an instruction or request from resident code such as an operating system or upon boot of the processor-based system. The instruction may request a secure environment be established within the system to allow private data, such as private data of a user, to be protected from unverified code or code that has not been authenticated and certified trustworthy.

Token 170 may comprise protected memory for integrity metrics and private data such as encryption keys. In many of these embodiments, the protected memory may comprise a platform control register (PCR). In one embodiment, PCR may only be extended by processor microcode commands, but may not be written to, and the resulting digest value may provide a root of trust for the system or a basis for evaluation of the trustworthiness of the processor-based system. In the present embodiment, token 170 may store the identity of a trusted module in identity repository 175 in a trusted manner and quote the identity in a trusted manner. For example, a second processor-system, a certification authority, or a second user on this processor-based system may review the identity and determine whether or not the processor-system is trustable to pass or exchange one or more types of private data. In many of these embodiments, token 170 may seal secrets such as encryption keys to a particular environment and may only unseal secrets to the environment to which they were sealed.

Token 170 may be implemented in different manners as an isolated component or as part of another component or device. In addition, the functions of token 170 may be separated and located in different components or devices. However, in one embodiment, token 170 is implemented to comply with the specification of the Trusted Platform Module (TPM) described in detail in the Trusted Computing Platform Alliance (TCPA) Main Specification, Version 1.1a, Dec. 1, 2001, issued by the TCPA.

Identity repository 175 may comprise protected memory to protect the identity or an index thereof from modification after registration. In embodiments wherein memory-resident trusted modules may be updated or replaced after initialization of the secured environment, token 170 may facilitate updates or replacements of the identity in identity repository 175. Other embodiments may not facilitate modifications to registered code without re-initialization of the corresponding secure environment.

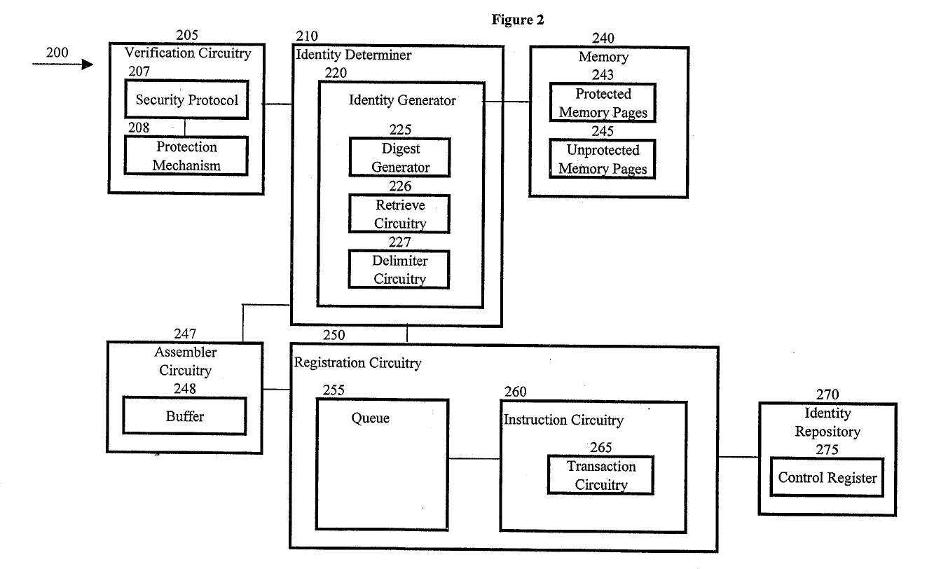

Referring now to FIG. 2, there is shown an embodiment of an apparatus to register code for a secure environment. The embodiment may comprise verification circuitry 205, identity determiner 210, memory 240, assembler circuitry 247, registration circuitry 250, and identity repository 270.

Verification circuitry 205 may verify that an instruction such as a special cycle follows a security protocol 207. The signal 200 may comprise complete or substantially complete identity for resident code. In instances wherein the special cycles may not be verified, verification circuitry 205 may ignore signal 200 or initiate a protection mechanism of protection mechanism 208 against the error since the error may comprise part of an attempt by hostile code to gain access to private data. Protection mechanism 208 may comprise, for example, a mechanism to initiate a shut down sequence for a secure environment to seal private data until an uncorrupted secure environment may be established, a sequence verify hardware configurations and authenticate registered code, a sequence to purge and re-initialize corrupted, registered code, or the like. For instance, verification circuitry 205, after detecting an erroneous special cycle, may authenticate memory-resident SVMM code against a registered identity for the SVMM code. When the registered SVMM code may not be authenticated, verification circuitry 205 may dismantle the secure environment.

Identity determiner 210 may derive the identity from a signal 200 comprising a request to register resident code. For instance, identity determiner 210 may receive a signal 200, determine that the special cycles incorporate an address associated with identity repository 270, and determine the identity based upon signal 200. The identity may substantially identify the resident code. In the present embodiment, signal 200 may comprise the identity transmitted via special cycles such as special cycles on a front side bus (FSB). In other embodiments, signal 200 may comprise resident code or an instruction to receive or retrieve an address indicating a memory location of the identity or resident code, or the like. After determining part of the identity, identity determiner 210 may forward the data in queue 255 of registration circuitry 250.

Identity determiner 210 may comprise identity generator 220. Identity generator 220 may determine the identity from signal 200. In some embodiments, identity generator 220 may decode the identity, determine receipt of the last part of the identity, and/or reassemble parts of the identity via assembler circuitry 247 in buffer 248 or memory 240. For example, in one embodiment, the identity may be generated in parts by more than one thread or processor so the identity may be received in more than signal 200 and the parts may not be received in order. Identity generator 220 may store the identity or parts of the identity in consecutive memory locations in queue 255. In other embodiments, identity generator 220 may comprise assembler circuitry 247 to reassemble the identity in buffer 228 or protected memory pages 243 of memory 240. In several of these embodiments, identity determiner 210 may forward parts of the identity to registration circuitry 250 in order or may forward a complete identity to registration circuitry 250. In alternative embodiments, assembler circuitry 247 may reassemble an encoded or encrypted identity from unprotected memory pages 245.

Identity generator 220 may comprise digest generator 225, retrieve circuitry 226, and delimiter circuitry 227. Digest generator 225 may cryptographically hash code from signal 200 or indicated by signal 200. For example, signal 200 may comprise an address to indicate the location(s) of a resident code in memory 240. Identity generator 220 may receive the location(s) and retrieve circuitry 226 may derive an identity based upon an address in the signal. Retrieve circuitry 226 may retrieve the resident code from the location(s) and digest generator 225 may generate a digest value based upon the resident code. In several of these embodiments, identity generator 220 may encrypt the digest value to determine the identity for the resident code. In other embodiments, the digest value may comprise the identity.

Delimiter circuitry 227 may determine receipt of the last part of the identity for a resident code. For example, the identity for a resident code may comprise a variable amount of data and the variable amount of data may be received via one or more signals 200. In many of these embodiments, the signal 200 comprising the last part of the identity for the resident code may comprise a sequence of bits or the like to demark the last part of the identity. In these embodiments, delimiter circuitry 227 may determine the last part of the identity to facilitate registration of the identity with the identity repository 270. In other embodiments, the identity repository 270 may recognize the last part of the identity. In further embodiments, the organization of the identity repository 270 or the procedures for evaluating the trustworthiness of resident code operate without regard to a demarcation of the last part of the identity for a resident code.

Memory 240 may comprise memory pages with restricted access to filter access to pages of memory 240 based upon the source of the memory access or based upon the source indicated by the request for access. In many embodiments, memory 240 may comprise protected memory pages 243 and unprotected memory pages 245. In other embodiments, addresses in memory 240 may be protected based upon address ranges or memory lines. Protected memory pages 243, for instance, may be accessed by trusted modules or selected trusted modules and access by other modules may be denied or ignored such as an access to protected memory pages 243 by unregistered code or code that may not be authenticated as a trusted module. For example, identity determiner 210 may receive part of the identity for an authenticated code. Identity determiner 210 may store the part of the identity in protected memory pages 243 until the remainder of the identity may be received. A hostile, unregistered code may have modified the authenticated software module and may attempt to access the identity in protected memory to adjust or extend the identity to match the identity of a trusted module that may be certified or determined to be trustworthy by another system. The hostile, unregistered code may attempt access via a graphics aperture to directly access memory 240. After a determination that the transaction is attempting access via the graphics aperture, the transaction may be denied access to protected memory, may be ignored, and/or may initiate a protection mechanism like protection mechanism 208 to take measures to protect private data from the hostile, unregistered code such as setting a crash register prior to taking down and/or re-initiating the secure environment.

Registration circuitry 250 may couple with identity determiner 210 to register the resident code based upon the identity. Registration circuitry 250 may comprise queue 255 and instruction circuitry 260. In some embodiments, queue 255 may comprise memory to temporarily store the identity prior to storing the data in identity repository 270. In several of these embodiments, queue 255 may comprise a first in, first out (FIFO) queue. For example, identity determiner 210 may determine an identity for a first authenticated code, transmit the identity to queue 255, and determine an identity for a second authenticated code prior to storage of the identity of the first authenticated code in control register 275 of identity repository 270. Registration circuitry 250 may forward the identity to identity repository 270 in enough writes to accommodate the size of the identity and any related additional bits to provide access information to identity repository 270 so part of the identity of the first authenticated code may still reside in queue 255 when the identity of the second trusted module is stored in queue 255. Registration circuitry 250 may continue to forward the identity of the first authenticated code to identity repository 270 prior to forwarding the identity of the second authenticated code.

Instruction circuitry 260 may couple with the protected memory such as control register 275 in identity repository 270 to initiate a substantially secure transmission between registration circuitry 250 and the protected memory. Instruction circuitry 260 may generate a transaction comprising the identity on the bus between registration circuitry 250 and identity repository 270 to initiate a transaction that may not be snooped by other components coupled with the bus. In some embodiments, another component or code may see the transaction on the bus but may not be able to place a cycle or data on the bus. The instruction may comprise a sequence of actions, transmissions, or the like. In the present embodiment, for instance, instruction circuitry 260 may comprise transaction circuitry 265 to transmit an identity to identity repository 270 via a special bus cycle. The special bus cycle may comprise unique or substantially unique start bits, an eight-bit fixed token address, and up to one byte of data at a time.

In alternative embodiments, for example, the bus may comprise a configurable point-to-point bus accomplished with magnetic coupling devices. The point-to-point bus may be reconfigured near initialization of a secure environment to provide a dedicated lane from registration circuitry 250 to identity repository 270. In further embodiments, the point-to-point bus may be reconfigured near initialization of the platform or a subsystem thereof.

Identity repository 270 may confirm or verify that an instruction is initiated by registration circuitry 250 and may provide protected memory for storage of platform encryption keys and one or more identities to register memory-resident code that implements the secure environment. In many embodiments, identity repository 270 may comprise control register 275 to store the identity. In further embodiments, identity repository 270 may comprise protection mechanisms like protection mechanism 208 to protect encryption keys or other integrity metrics or private data from unauthorized access. For example, one embodiment may comprise a protection mechanism to write to a secrets register to indicate that erroneous and/or hostile access has been attempted on identity repository 270.

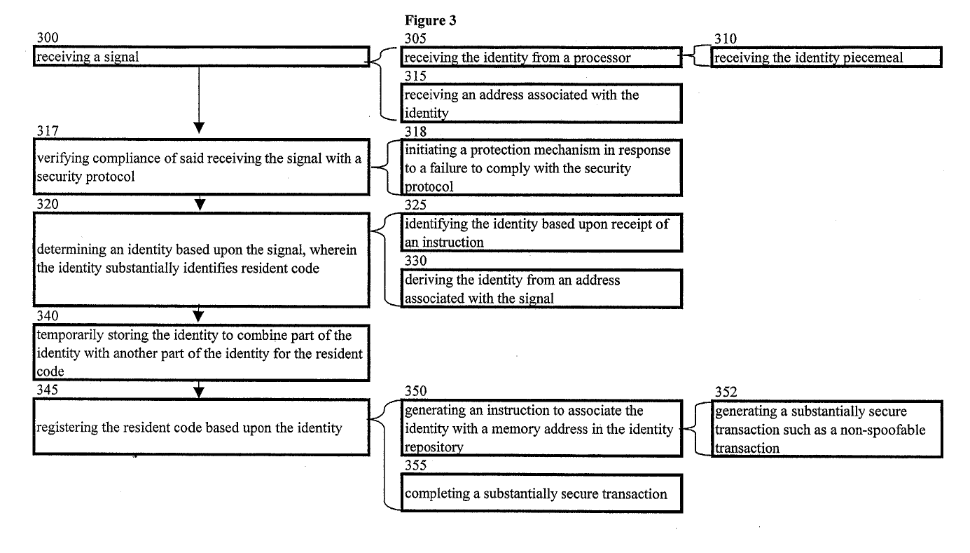

Referring now to FIG. 3, there is shown a flow chart of an embodiment to register code for a secure environment. The embodiment comprises receiving a signal 300, verifying compliance of said receiving the signal with a security protocol 317, determining an identity based upon the signal, wherein the identity substantially identifies resident code 320, temporarily storing the identity to combine part of the identity with another part of the identity for the resident code 340, and registering the resident code based upon the identity 345. Receiving a signal 300 may receive a signal representing a request to store an identity in protected memory such as a repository for the identity. In several embodiments, the signal may be initiated by a processor designated as an initiating logical processor (ILP). The ILP may comprise one physical processor or a thread executing on one or more physical processor. In many embodiments, receiving a signal 300 may comprise receiving a signal that comprises an instruction. The instruction may comprise a special cycle having a substantially unique sequence of bits to identify the transaction as a transaction intended to store the identity in protected memory. In one such embodiment, a security protocol may be defined to determine when a processor may initiate an instruction such as a special cycle.

Receiving a signal 300 may comprise receiving the identity from a processor 305, receiving an address associated with the identity 315, or the like. Receiving the identity from a processor 305 may comprise receiving a signal that comprises the identity. For example, the processor such as a logical processor may generate a digest value based upon the resident code. The resident code may comprise code executed to initiate and/or maintain a secure environment, wherein the secure environment may comprise an environment to protect private data from being released to untrustworthy code or systems. The digest value may comprise the identity for the resident code or the processor may encrypt the digest value and the encrypted version of the code may represent the identity. The processor may then, in accordance with a security protocol, transmit the identity to a chipset or hub.

In some embodiments, receiving the identity from a processor 305 may comprise receiving the identity piecemeal 310. In many such embodiments, the processor or logical processor may perform other operations while generating the identity or while transmitting the identity. As a result, receiving the identity piecemeal 310 may comprise receiving multiple transactions rather than an atomic transaction, wherein a transaction may comprise part of the identity for a resident code. Other embodiments may comprise encrypting a hash of the resident code received from a processor.

Receiving an address associated with the identity 315 may comprise receiving an address located in memory that may comprise the identity. In particular, part or all of the identity for a resident code may be stored in memory such as protected or unprotected memory prior to receiving the signal 300. In many embodiments, the identity may be determined as a whole and stored at an address in memory. In other embodiments, the identity may be determined in a time-sliced manner. When a digest value is generated in a time-sliced manner, for instance, a security protocol and/or other precautions may ensure that another process may not affect the digest value. For example, an arbitration mechanism operating in accordance with a security protocol may allocate processing time to more than one logical processor so a logical processor may generate a digest value for a resident code in small parts. Generating a transaction to store such a small part of the identity in an identity repository may be inefficient or otherwise uneconomical so the logical processor may store parts of the identity in other protected memory until a more efficient or economical amount of the identity may be incorporated into a transaction to register the resident code.

Verifying compliance of said receiving the signal with a security protocol 317 may verify that the context of the transaction to receive the signal may comply with the security protocol defined to prevent access to the idenitity repository by code other than a trusted module. Verifying compliance of said receiving the signal with a security protocol 317 may comprise initiating a protection mechanism in response to a failure to comply with the security protocol 318. Initiating a protection mechanism in response to a failure to comply with the security protocol 318 may comprise setting a crash flag and initiating a shut down procedure for the secure environment or setting an error flag to monitor the number and/or types of erroneous requests to access protected memory or perform trusted operations.

Determining an identity based upon the signal, wherein the identity substantially identifies resident code 320 may interpret the signal to prepare the identity for registration. Registration of the identity may comprise storing the identity in a pre-defined repository for the identity or may comprise storing the identity in protected memory and storing an indication of the location of the identity in an index for the identity.

Determining an identity based upon the signal, wherein the identity substantially identifies resident code 320 may comprise identifying the identity based upon receipt of an instruction 325 and deriving the identity from an address associated with the signal 330. Identifying the identity based upon receipt of an instruction 325 may comprise recognizing an instruction that represents a valid request to store an identity and determining the request complies with a security protocol. For example, a secure environment may be initiated by an authenticated chipset code such as SINIT. The authenticated code may define a security protocol and/or instruction for one or more processors or threads. The instruction may comprise, for instance, a special cycle to identify a transaction between a processor and the hub as a request to register code. The request may comprise an address indicating the address to store an identity or an index for the identity based upon the resident code. The chipset may recognize the transaction as valid based upon the structure of the transaction data and/or based upon a sequence of actions by the processor. After verifying the validity of the transaction, the chipset may acquire and/or generate the identity for the resident code and/or store the identity, or an index thereof, in a register or queue to forward to a repository to register the resident code. Embodiments that may generate the identity may cryptographically hash a memory-resident code.

Deriving the identity from an address associated with the signal 330 may comprise retrieving the identity from protected memory. After receiving a signal 300, the identity may be retrieved from the memory address or location. Retrieving the identity from protected memory may comprise determining the memory location resides in a protected memory page and/or verifying that the source agent of the request, like a chipset, is a trusted agent. In one embodiment, the chipset or hub may comprise a high level trusted agent. In other embodiments, determining an identity based upon the signal, wherein the identity substantially identifies resident code 320 may comprise generating the identity from the resident code.

Further embodiments may comprise temporarily storing the identity to combine part of the identity with another part of the identity for the resident code 340. Temporarily storing the identity to combine part of the identity with another part of the identity for the resident code 340 may comprise storing the identity in a temporary register, such as a register within a chipset or hub. Temporarily storing the identity to combine part of the identity with another part of the identity for the resident code 340 may facilitate registering the identity with an atomic transaction and/or may facilitate the performance of multiple operations or substantially concurrent operations by one or more processors.

Registering the resident code based upon the identity 345 may initiate and, in some embodiments, verify completion of a transaction to register resident code. Registering the resident code based upon the identity 345 may comprise generating an instruction to associate the identity with a memory address in the identity repository 350 and completing the substantially secure transaction 355. Generating an instruction to associate the identity with a memory address in the identity repository 350 may comprise initiating an instruction to store the identity for resident code, or a memory location therefore, in an identity repository. In embodiments wherein the identity repository may comprise a memory location, such as a token, the token may require the instruction to provide access to the memory location. These embodiments may generate the instruction and write the identity to the protected memory of the token. Many of these embodiments may comprise generating a substantially secure transaction 352 to transmit the identity to the token and the token may write the data to protected memory. In some embodiments, generating a substantially secure transaction may generate a non-spoofable transaction or a transaction that may be unaffected by other circuitry. For instance, the other circuitry may read the content of the transaction but may be unable to adjust or modify the content of the transaction.

Completing the substantially secure transaction 355 may comprise receiving a completion to indicate successful registration of the resident code or receiving an indication that the transaction may not have been changed by a component or code during the transaction. In many of these embodiments, an unsuccessful registration of the resident code may be followed by a subsequent attempt(s) to register the resident code. Further embodiments may comprise protection mechanisms to terminate or take down a secure environment in response to two or more unsuccessful attempts to register the resident code.

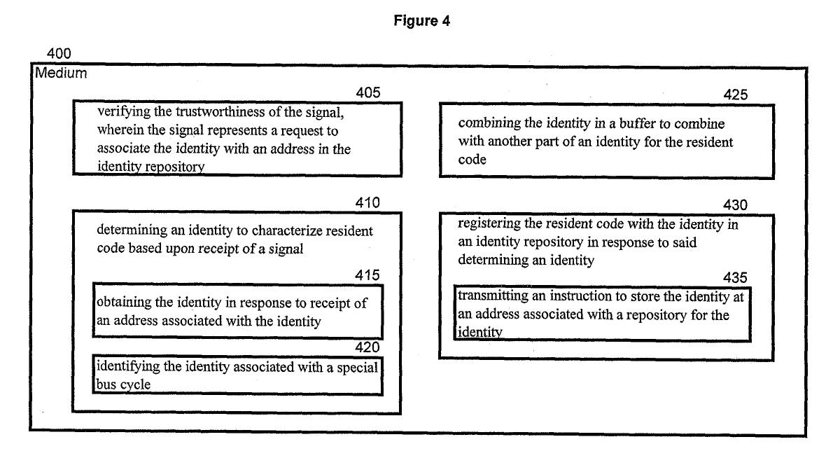

Referring now to FIG. 4, a machine-readable medium embodiment of the present invention is shown. A machine-readable medium includes any mechanism that provides (i.e. stores and or transmits) information in a form readable by a machine (e.g., a computer), that when executed by the machine, may perform the functions described herein. For example, a machine-readable medium may include read only memory (ROM); random access memory (RAM); magnetic disk storage media; optical storage media; flash memory devices; electrical, optical, acoustical or other form of propagated signals (e.g. carrier waves, infrared signals, digital signals, etc.); etc . . . Several embodiments of the present invention may comprise more than one machine-readable medium depending on the design of the machine.

In particular, FIG. 4 shows an embodiment of a machine-readable medium 400 comprising instructions, which when executed by a machine, cause said machine to perform operations, comprising verifying the trustworthiness of the signal, wherein the signal represents a request to associate the identity with an address in the identity repository 405; determining an identity to characterize resident code based upon receipt of a signal 410; combining the identity in a buffer to combine with another part of an identity for the resident code 425; and registering the resident code with the identity in an identity repository in response to said determining an identity 430. Verifying the trustworthiness of the signal, wherein the signal represents a request to associate the identity with an address in the identity repository 405 may comprise comparing the signal and/or actions of the source of the signal subsequent to receiving the signal to a security protocol. For instance, prior to the establishment of a secure environment, wherein a trusted module such as SVMM may monitor access to protected memory locations, a security protocol may describe a special bus cycle and/or an interval for initialization of a special bus cycle. After the establishment of a secure environment, the security protocol may facilitate transactions such as a request to register memory-resident code during normal bus cycles by a trusted module.

Determining an identity to characterize resident code based upon receipt of a signal 410 may determine the receipt of an instruction to register memory-resident code and, in some embodiments, extract the identity from the signal. Determining an identity to characterize resident code based upon receipt of a signal 410 may comprise obtaining the identity in response to receipt of an address associated with the identity 415 and identifying the identity associated with a special bus cycle 420. Obtaining the identity in response to receipt of an address associated with the identity 415 may comprise acquiring the identity from an address in memory or generating the identity based upon a code located at an address in memory.

Identifying the identity associated with a special bus cycle 420 may comprise determining that a starting sequence of actions or bits associated with a special bus cycle, represent a request from a trusted source to store an identity in a repository for the identity associated with a secure environment. The trusted source, in several embodiments, may comprise circuitry operating in accordance with trusted module or authenticated code. For example, the trusted source may comprise circuitry of a processor operating in accordance with SINIT or SVMM.

Further embodiments may comprise combining the identity in a buffer to combine with another part of an identity for the resident code 425. Combining the identity in a buffer to combine with another part of an identity for the resident code 425 may allow a processor or threads functioning as logical processors to transmit an identity piecemeal. One or more parts of the identity for a resident code may then be assembled to store in the identity repository piecemeal or as an atomic transaction.

Registering the resident code with the identity in an identity repository in response to said determining an identity 430 may comprise generating a transaction that may not be observed by other agents on a bus that may facilitate storage of an identity and/or a representation thereof in protected memory. In further embodiments, registering the resident code with the identity in an identity repository in response to said determining an identity 430 may comprise establishing access by a hub or the like with protected memory, such as a token, within the hub.

Registering the resident code with the identity in an identity repository in response to said determining an identity 430 may comprise transmitting an instruction to store the identity at an address associated with a repository for the identity 435. Transmitting an instruction to store the identity at an address associated with a repository for the identity 435 may comprise transacting with a token to request access to protected memory within and/or managed by the token.

What is claimed is:

1. An apparatus, comprising:
an identity determiner to determine an identity based upon receipt of a signal to describe memory-resident code; and
registration circuitry coupled with said identity determiner to register the memory-resident code with an identity repository based upon the identity.

2. The apparatus of claim 1, further comprising a bus to couple said registration circuitry to the identity repository.

3. The apparatus of claim 1, further comprising verification circuitry coupled with said identity determiner to verify compliance of the signal with a security protocol.

4. The apparatus of claim 1, further comprising assembler circuitry coupled with said identity determiner to combine parts of the identity for registration.

5. The apparatus of claim 4, wherein the assembler circuitry comprises a mechanism to store part of the identity to combine with another part of the identity for the resident code.

6. The apparatus of claim 1, wherein said identity determiner comprises delimiter circuitry to determine receipt of the last part of the identity for the resident code.

7. The apparatus of claim 1, wherein said identity determiner comprises retrieve circuitry to derive the identity based upon a memory address.

8. The apparatus of claim 1, wherein said identity determiner comprises a digest generator to hash the memory-resident code to generate the identity.

9. The apparatus of claim 1, wherein said registration circuitry comprises instruction circuitry coupled with the identity repository to store the identity.

10. The apparatus of claim 9, wherein the instruction circuitry comprises a transaction circuitry to generate a substantially secure transaction to associate the identity with the identity repository.

11. A method, comprising:
receiving a signal;
determining an identity based upon the signal, wherein the identity substantially identifies resident code; and
registering the resident code based upon the identity.

12. The method of claim 11, further comprising temporarily storing the identity to combine part of the identity with another part of identity for the resident code.

13. The method of claim 11, further comprising verifying compliance of said receiving the signal with a security protocol.

14. The method of claim 13, wherein verifying compliance comprises initiating a protection mechanism in response to a failure to comply with the security protocol.

15. The method of claim 11, wherein said receiving the signal comprises receiving an address associated with the identity.

16. The method of claim 11, wherein said determining an identity comprises identifying the identity based upon receipt of an instruction.

17. The method of claim 11, wherein said determining an identity comprises deriving the identity from an address associated with the signal.

18. The method of claim 11, wherein said registering comprises generating an instruction to associate the identity with a memory address in the identity repository.

19. The method of claim 18, wherein generating an instruction comprises generating a substantially secure transaction.

20. A system, comprising:
a microprocessor to generate a signal associated with an identity for resident code;
an identity determiner coupled with said microprocessor to receive the signal and derive the identity based upon the signal;
registration circuitry coupled with said identity determiner to store the resident code in protected memory to associate the identity with an identity repository; and
a token coupled with said registration circuitry to maintain the identity repository for evaluation of trustworthiness of the resident code.

21. The system of claim 20, further comprising a bus to couple said token with said registration circuitry.

22. The system of claim 20, further comprising verification circuitry coupled with said microprocessor to verify compliance of receipt of the signal with a security protocol.

23. The system of claim 20, further comprising assembler circuitry coupled with said identity determiner to assemble parts of the identity based upon the signal.

24. The system of claim 20, wherein said identity determiner comprises delimiter circuitry to determine the identity based upon the signal.

25. The system of claim 20, wherein said registration circuitry comprises instruction circuitry to extend a content of the identity repository.

26. The system of claim 20, wherein said registration circuitry comprises instruction circuitry to generate an instruction to access said token.

27. A machine-readable medium containing instructions, which when executed by a machine, cause said machine to perform operations, comprising:
determining an identity to characterize resident code based upon receipt of a signal; and
registering the resident code with the identity in an identity repository in response to said determining an identity.

28. The machine-readable medium of claim 27, further comprising verifying the trustworthiness of the signal, wherein the signal represents a request to associate the identity with an address in the identity repository.

29. The machine-readable medium of claim 27, further comprising combining the identity in a buffer to combine with another part of an identity for the resident code.

30. The machine-readable medium of claim 27, wherein said registering comprises generating a substantially secure transaction for a bus coupled with the identity repository to register the resident code.
